(19) United States
(12) Patent Application Publication
(10) Pub. No.: US 2009/0049141 A1
(43) Pub. Date: Feb. 19, 2009

(54) TRACKING DELIVERED E-MAIL

(75) Inventors: Angela Richards Jones, Durham, NC (US); Ruthie D. Lyle, Durham, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/840,705

(22) Filed: Aug. 17, 2007

(51) Int. Cl. G06F 15/16

(52) U.S. Cl. 709/206

(57) ABSTRACT

Embodiments of the present invention address deficiencies of the art in respect to return receipt processing for e-mail messages and provide a method, system and computer program product for tracking delivered e-mail messages. In one embodiment of the invention, an e-mail tracking method can be provided. The method can include selecting an e-mail message already sent to a designated recipient, forwarding a status request to the designated recipient to determine a status of the e-mail message already sent to the designated recipient, and receiving in return without the intervention of the designated recipient a return receipt for the e-mail message indicating the status of the e-mail message.

### BACKGROUND OF THE INVENTION

1. Field of the Invention

The present invention relates to the field of electronic mail (e-mail) management and more particularly tracking set messages in an e-mail system.

2. Description of the Related Art

Electronic messaging represents the single most useful task accomplished over wide-scale computer communications networks. Some argue that in the absence of electronic messaging, the Internet would have amounted to little more than a science experiment. Today, electronic messaging seems to have replaced the ubiquitous telephone and fax machine for the most routine of interpersonal communications. As such, a variety of electronic messaging systems have arisen which range from real-time instant messaging systems and wireless text pagers to asynchronous electronic mail systems.

Electronic mail, a form of electronic messaging referred to in the art as e-mail, has proven to be the most widely used computing application globally. Though e-mail has been a commercial staple for several decades, due to the explosive popularity and global connectivity of the Internet, e-mail has become the preferred mode of communications, regardless of the geographic separation of communicating parties. Today, more e-mails are processed in a single hour than phone calls. Clearly, e-mail as a mode of communications has been postured to replace all other modes of communications, save for voice telephony.

Oftentimes, it will be important for a sender of an e-mail message to know when a recipient not only receives the e-mail message, but also when the recipient opens the e-mail message. In the latter circumstance, the e-mail message will have been considered “read”. Most commercially distributed e-mail clients provide for a “return receipt” to notice the sender when a sent message has become read. In this regard, the e-mail recipient of a received message can recognize a return-receipt attribute, and upon detecting the opening of the received message, the sender of the received message can be sent a separate e-mail message indicating that the message has been “read”.

Within most commercially distributed e-mail clients, the return-receipt requested attribute can be selected by default such that a return receipt is requested of all outbound e-mail messages. However, an end user can become quickly overwhelmed with return receipts where a reasonable volume of e-mail messages are sent on a daily basis. Thus, most users prefer to manually set the return-receipt attribute. Notwithstanding, on many occasions, a sender will not select the return-receipt attribute for an e-mail message unless a compelling need to do so is known in advance. Yet, for the non-responsive e-mail recipient, a sender of an e-mail message can become frustrated without knowing whether or not the recipient has read a sent message. Even still, once an e-mail message has been sent, there is no way to retroactively apply the return-receipt requested attribute.

### BRIEF SUMMARY OF THE INVENTION

Embodiments of the present invention address deficiencies of the art in respect to return receipt processing for e-mail messages and provide a novel and non-obvious method, system and computer program product for tracking delivered e-mail messages. In one embodiment of the invention, an e-mail tracking method can be provided. The method can include selecting an e-mail message already sent to a designated recipient, forwarding a status request to the designated recipient to determine a status of the e-mail message already sent to the designated recipient, and receiving in return without the intervention of the designated recipient a return receipt for the e-mail message indicating the status of the e-mail message.

In one aspect of the embodiment, selecting an e-mail message already sent to a designated recipient can include selecting an e-mail message already sent to a designated recipient from amongst other already sent e-mail messages in a sent folder of an e-mail client. In another aspect of the embodiment, receiving in return without the intervention of the designated recipient a return receipt for the e-mail message indicating the status of the e-mail message can include receiving in return without the intervention of the designated recipient an e-mail message including a return receipt indicating the status of the e-mail message already sent to a designated recipient. Alternatively, receiving in return without the intervention of the designated recipient a return receipt for the e-mail message indicating the status of the e-mail message, can include receiving in return without the intervention of the designated recipient a return receipt for the e-mail message indicating whether or not the e-mail message has been opened by the designated recipient.

In another embodiment of the invention, an e-mail management data processing system can be configured for e-mail message tracking. The system can include e-mail clients coupled to an e-mail server and a message store of e-mail messages coupled to the e-mail server. The system also can include e-mail message tracking logic. The logic can include program code enabled to receive from a requesting one of the e-mail clients a return receipt request for a e-mail message already sent to a designated recipient and stored in the message store, to determine a status of the e-mail message, and to forward to the requesting one of the e-mail clients without requiring intervention by the designated recipient a return receipt for the e-mail message indicating the status of the e-mail message. In one aspect of the embodiment, the status can include a status selected from the group consisting of read and unread. In another aspect of the embodiment, the requesting one of the e-mail clients can include a sent folder, and the sent folder can include a return receipt control activatable to generate the return receipt request for a selected e-mail message in the sent folder.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for tracking delivered e-mail messages;

FIG. 2 is a schematic illustration of an e-mail messaging data processing system configured for tracking delivered e-mail messages; and,

FIG. 3 is a flow chart illustrating a process for tracking delivered e-mail messages.

### DETAILED DESCRIPTION OF THE INVENTION

Embodiments of the present invention provide a method, system and computer program product for tracking delivered e-mail messages. In accordance with an embodiment of the present invention, a return-receipt request can be forwarded on behalf of a sender to a recipient in connection with an e-mail message already transmitted and delivered into the inbox of the recipient. Upon receipt of the return-receipt request, the already transmitted and delivered e-mail message can be inspected to determine whether or not the e-mail message has been opened. Thereafter, a return-receipt can be provided to the sender indicating whether or not the already transmitted and delivered e-mail message has been opened.

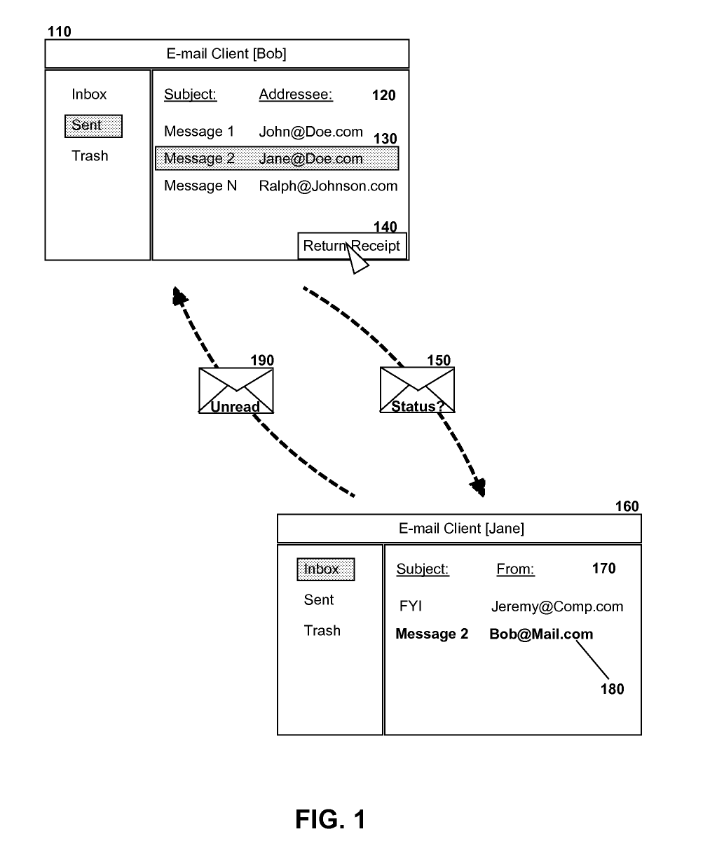

In illustration, FIG. 1 is a pictorial illustration of a process for tracking delivered e-mail messages. As shown in FIG. 1, e-mail messages can be composed and transmitted to designated addressees through e-mail client 110. Once an e-mail message has been transmitted to a designated addressee, the e-mail message can appear in a “sent” folder 120 in the e-mail client 110 of a message sender. The sent folder 120 can include a listing of e-mail messages sent to respective designated addressees. In accordance with an embodiment of the present invention, a particular one of the e-mail messages 130 listed in the sent folder 120 can be selected and a return receipt control 140 can be activated in order to request a return receipt for the particular one of the e-mail messages 130.

In response to the activation of the return receipt control 140, a status message 150 can be forwarded to the addressee associated with the particular one of the e-mail messages 130. The status message 150 can be received in a mail server for the addressee and a status can be determined for a counterpart e-mail message 180 in the inbox 170 of an e-mail client 160 for the addressee. Thereafter, a reply message 190 can be returned to the sender indicating a contemporaneous status of the counterpart e-mail message 180, for example “unread”, “opened”, “deleted”, “forwarded”, etc. In this way, the effect of a return receipt can be imparted on the counterpart e-mail message 180 though a return receipt may not have been requested at the time of transmitting the particular one of the e-mail messages 130.

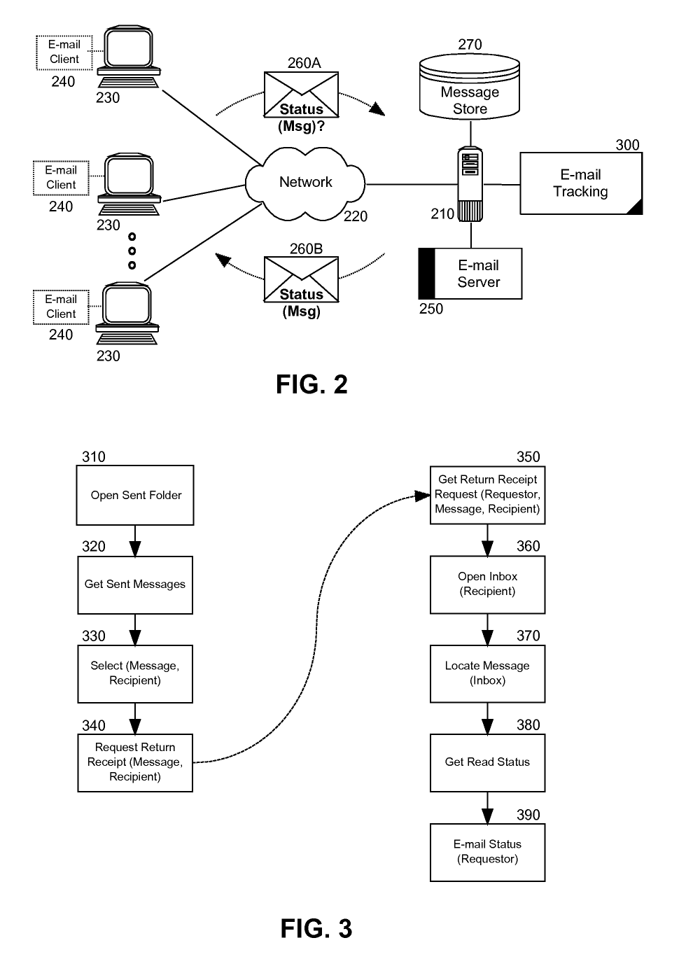

The process illustrated in FIG. 1 can be embodied within an e-mail messaging data processing system. In further illustration, FIG. 2 schematically depicts an e-mail messaging data processing system configured for tracking delivered e-mail messages. The system can include a host server 210 configured for communicative coupling to one or more computing devices 230 over computer communications network 220, each device 230 hosting the execution of an e-mail client 240. The host server 210 also can be configured to support the operation of an e-mail server 250. The e-mail server 250 can be programmed to access message store 270 in the composition, transmission, receipt and management of e-mail messages amongst the e-mail clients 240.

Notably, e-mail tracking logic 300 can be coupled to the e-mail server 250 by way of the host computing platform 210. The e-mail tracking logic 300 can include program code enabled to receive a return receipt request 260A transmitted a requesting one of the e-mail clients 240 in respect to an e-mail message previously transmitted to and received by another of the e-mail clients 240. The e-mail tracking logic 300 further can include program code enabled in response to receiving the return receipt request 260 to ascertain a current status of the e-mail message and to provide a return receipt 260B to the requesting one of the e-mail clients 240 even though a return receipt 260B had not been originally requested prior to the transmission of the e-mail.

In yet further illustration of the operation of the e-mail tracking system, FIG. 3 is a flow chart depicting a process for tracking delivered e-mail messages. Beginning in block 310, a sent folder can be opened in which different e-mail messages having already been sent to designated recipient are listed. In block 320, the sent messages can be displayed and in block 330, one of the sent messages can be selected. Thereafter, in block 340, a return receipt request can be generated to include an identification of the selected sent message along with a return address for the requestor. Once generated, the return receipt request can be forwarded to the same address that had previously received the sent message.

In block 350, the return receipt request can be received in a mail server managing e-mail messages for the recipient of the sent message. In block 360, the inbox of the recipient can be opened and in block 370, the sent message referenced by the return receipt can be located. Thereafter, in block 380 the status of the sent message in the inbox can be determined, for instance, whether or not the sent message has been opened, deleted, forwarded, replied to and the like. Finally, in block 390 the status can be included in a return receipt e-mail message and addressed to the requestor. The return receipt then can be forwarded to the requester as an e-mail message. In this way, a return receipt can be retroactively requested for a sent e-mail message.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. An e-mail tracking method comprising:
selecting an e-mail message already sent to a designated recipient;
forwarding a status request to the designated recipient to determine a status of the e-mail message already sent to the designated recipient; and,
receiving in return without the intervention of the designated recipient a return receipt for the e-mail message indicating the status of the e-mail message.

2. The method of claim 1, wherein selecting an e-mail message already sent to a designated recipient, comprises selecting an e-mail message already sent to a designated recipient from amongst other already sent e-mail messages in a sent folder of an e-mail client.

3. The method of claim 1, wherein receiving in return without the intervention of the designated recipient a return receipt for the e-mail message indicating the status of the e-mail message, comprises receiving in return without the intervention of the designated recipient an e-mail message including a return receipt indicating the status of the e-mail message already sent to a designated recipient.

4. The method of claim 1, wherein receiving in return without the intervention of the designated recipient a return receipt for the e-mail message indicating the status of the e-mail message, comprises receiving in return without the intervention of the designated recipient a return receipt for the e-mail message indicating whether or not the e-mail message has been opened by the designated recipient.

5. An e-mail management data processing system configured for e-mail message tracking, the system comprising:
a plurality of e-mail clients coupled to an e-mail server;
a message store of e-mail messages coupled to the e-mail server; and,
e-mail message tracking logic comprising program code enabled to receive from a requesting one of the e-mail clients a return receipt request for a e-mail message already sent to a designated recipient and stored in the message store, to determine a status of the e-mail message, and to forward to the requesting one of the e-mail clients without requiring intervention by the designated recipient a return receipt for the e-mail message indicating the status of the e-mail message.

6. The system of claim 5, wherein the status comprises a status selected from the group consisting of read and unread.

7. The system of claim 5, wherein the requesting one of the e-mail clients comprises a sent folder, and wherein the sent folder comprises a return receipt control activatable to generate the return receipt request for a selected e-mail message in the sent folder.

8. A computer program product comprising a computer usable medium embodying computer usable program code for e-mail tracking, the computer program product comprising:
computer usable program code for selecting an e-mail message already sent to a designated recipient;
computer usable program code for forwarding a status request to the designated recipient to determine a status of the e-mail message already sent to the designated recipient; and,
computer usable program code for receiving in return without the intervention of the designated recipient a return receipt for the e-mail message indicating the status of the e-mail message.

9. The computer program product of claim 8, wherein the computer usable program code for selecting an e-mail message already sent to a designated recipient, comprises computer usable program code for selecting an e-mail message already sent to a designated recipient from amongst other already sent e-mail messages in a sent folder of an e-mail client.

10. The computer program product of claim 8, wherein the computer usable program code for receiving in return without the intervention of the designated recipient a return receipt for the e-mail message indicating the status of the e-mail message, comprises computer usable program code for receiving in return without the intervention of the designated recipient an e-mail message including a return receipt indicating the status of the e-mail message already sent to a designated recipient.

11. The computer program product of claim 8, wherein the computer usable program code for receiving in return without the intervention of the designated recipient a return receipt for the e-mail message indicating the status of the e-mail message, comprises computer usable program code for receiving in return without the intervention of the designated recipient a return receipt for the e-mail message indicating whether or not the e-mail message has been opened by the designated recipient.
